(19) United States
(12) Patent Application Publication
(10) Pub. No.: US 2007/0103402 A1
(43) Pub. Date: May 10, 2007

(54) Plasma display apparatus and method of driving the same

(75) Inventor: Kyu Choon Cho, Yongin-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/585,195

(22) Filed: Oct. 24, 2006

(30) Foreign Application Priority Data
Oct. 25, 2005 (KR) 10-2005-0101011

(51) Int. Cl. G09G 3/28

(52) U.S. Cl. 345/68

(57) ABSTRACT

A plasma display apparatus and a method of driving the same are disclosed. The plasma display apparatus includes a plasma display panel including a scan electrode, and a scan driver. The scan driver supplies a setup pulse to the scan electrode through resonance between the plasma display panel and a setup inductor. The method of driving the plasma display apparatus includes supplying a first voltage to the scan electrode during a reset period, and supplying a pulse gradually rising from the first voltage to a second voltage to the scan electrode during the reset period through resonance between the plasma display panel and the inductor.

This Nonprovisional application claims priority under 35 U.S.C. § 119 (a) on Patent Application No. 10-2005-0101011 filed in Korea on Oct. 25, 2005 the entire contents of which are hereby incorporated by reference.

### BACKGROUND

1. Field

This document relates to a display apparatus, and more particularly, to a plasma display apparatus and a method of driving the same.

2. Description of the Related Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs forms unit discharge cell or discharge cells. Each of discharge cells is filled with a main discharge gas such as neon (Ne), helium (He) and a mixture of Ne and He, and an inert gas containing a small amount of xenon (Xe).

The plurality of discharge cells form one pixel. For example, a red (R) discharge cell, a green (G) discharge cell and a blue (B) discharge cell form one pixel.

When the plasma display panel is discharged by a high frequency voltage, the inert gas generates vacuum ultraviolet light, which thereby causes phosphors formed between the barrier ribs to emit light, thus displaying an image. Since the plasma display panel can be manufactured to be thin and light, it has attracted attention as a next generation display device.

### SUMMARY

In one aspect, a plasma display apparatus comprises a plasma display panel comprising a scan electrode, and a scan driver for supplying a setup pulse to the scan electrode through resonance between the plasma display panel and a setup inductor.

In another aspect, a plasma display apparatus comprises a plasma display panel comprising a scan electrode, a sustain pulse supply unit for supplying a first voltage to the scan electrode, and a setup pulse supply unit for supplying a setup pulse gradually rising from the first voltage to a second voltage to the scan electrode through resonance between the plasma display panel and an inductor.

In still another aspect, a method of driving the plasma display apparatus comprises supplying a first voltage to a scan electrode during a reset period, and supplying a pulse gradually rising from the first voltage to a second voltage to the scan electrode during the reset period through resonance between a plasma display panel and an inductor.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a general plasma display apparatus according to an embodiment;

FIG. 2 illustrates an example of the structure of a plasma display panel of the plasma display apparatus;

FIG. 3 illustrates a driving waveform produced by the plasma display apparatus according to the embodiment;

FIG. 4 illustrates a scan driver of the plasma display apparatus according to the embodiment;

FIGS. 5 to 7 illustrate a current path for producing a setup pulse of the driving waveform produced by the plasma display apparatus according to the embodiment;

FIG. 8 illustrates an equivalent circuit of a closed loop formed by the current path illustrated in FIG. 7; and

FIG. 9 illustrates a voltage supplied to a panel capacitor of FIG. 8.

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel comprising a scan electrode, and a scan driver for supplying a setup pulse to the scan electrode through resonance between the plasma display panel and a setup inductor.

The scan driver may comprise a setup capacitor charged to a setup voltage supplied from a setup voltage source, a setup switch, connected between the setup voltage source and the scan electrode, for controlling the supplying of the setup voltage to the scan electrode, and the setup inductor connected between the setup switch and the scan electrode.

A magnitude of the highest voltage of the setup pulse may range from a sum of a magnitude of a sustain voltage and a magnitude of a setup voltage to a sum of the magnitude of the sustain voltage and two times the magnitude of the setup voltage.

A plasma display apparatus comprises a plasma display panel comprising a scan electrode, a sustain pulse supply unit for supplying a first voltage to the scan electrode, and a setup pulse supply unit for supplying a setup pulse gradually rising from the first voltage to a second voltage to the scan electrode through resonance between the plasma display panel and an inductor.

The first voltage may be equal to a sustain voltage level.

The setup pulse supply unit may comprise a setup capacitor charged to a setup voltage supplied from a setup voltage source, a setup switch, connected between the setup voltage source and the scan electrode, for controlling the supplying of the setup voltage to the scan electrode, and a setup inductor, connected between the setup switch and the scan electrode, for supplying a charge voltage to the setup capacitor to the scan electrode through resonance between the plasma display panel and the setup inductor.

A magnitude of a difference between the second voltage and the first voltage may range from a magnitude of the setup voltage to two times the magnitude of the setup voltage.

The sustain pulse supply unit may comprise a sustain voltage supply controller, connected between the scan electrode and a sustain voltage source, for controlling the supplying of the sustain voltage to the scan electrode, and a ground level voltage supply controller, connected between the scan electrode and a ground level voltage source, for controlling the supplying of a ground level voltage to the scan electrode.

A current path for charging the setup capacitor to the setup voltage may pass through the setup voltage source, the setup capacitor, the ground level voltage supply controller and the ground level voltage source.

A current path for supplying a charge voltage to the setup capacitor to the scan electrode through the resonance between the plasma display panel and the setup inductor may pass through the setup capacitor, the setup switch, the setup inductor and the plasma display panel.

One terminal of the setup capacitor may be connected to the setup voltage source, and the other terminal of the setup capacitor may be connected to a drain terminal of the ground level voltage supply controller. A drain terminal of the setup switch may be commonly connected to one terminal of the setup capacitor and the setup voltage source, and a source terminal of the setup switch may be connected to one terminal of the setup inductor. The other terminal of the setup inductor may be connected to the scan electrode.

The setup pulse supply unit may comprise an inductor.

A method of driving the plasma display apparatus comprises supplying a first voltage to a scan electrode during a reset period, and supplying a pulse gradually rising from the first voltage to a second voltage to the scan electrode during the reset period through resonance between a plasma display panel and an inductor.

The first voltage may be equal to a sustain voltage level.

The supplying of the pulse gradually rising from the first voltage to the second voltage may comprise charging a setup capacitor to a setup voltage, and supplying a charge voltage to a setup capacitor to the scan electrode through the resonance between the plasma display panel and the inductor.

A magnitude of a difference between the second voltage and the first voltage may range from a magnitude of the setup voltage to two times the magnitude of the setup voltage.

Hereinafter, exemplary embodiments of the present invention will be described in detail with reference to the attached drawings.

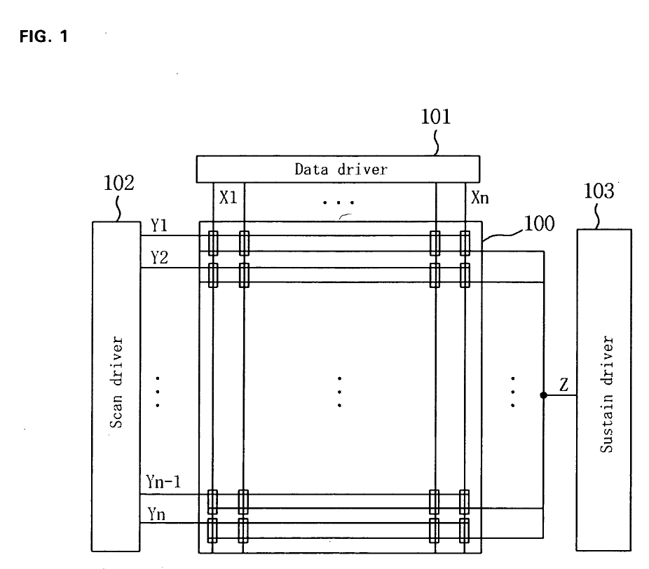

FIG. 1 illustrates a general plasma display apparatus.

As illustrated in FIG. 1, the plasma display apparatus comprises a plasma display panel 100 and a driver for supplying a predetermined driving voltage to electrodes of the plasma display panel 100, preferably, a data driver 101, a scan driver 102 and a sustain driver 103.

The scan driver 102 and the sustain driver 103 may be called a first driver, and the data driver 101 maybe called a second driver.

A front panel (not illustrated) and a rear panel (not illustrated) of the plasma display panel 100 are coalesced with each other at a given distance. A plurality of electrodes, for example, a plurality of scan electrodes Y and a plurality of sustain electrodes are formed in the plasma display panel 100.

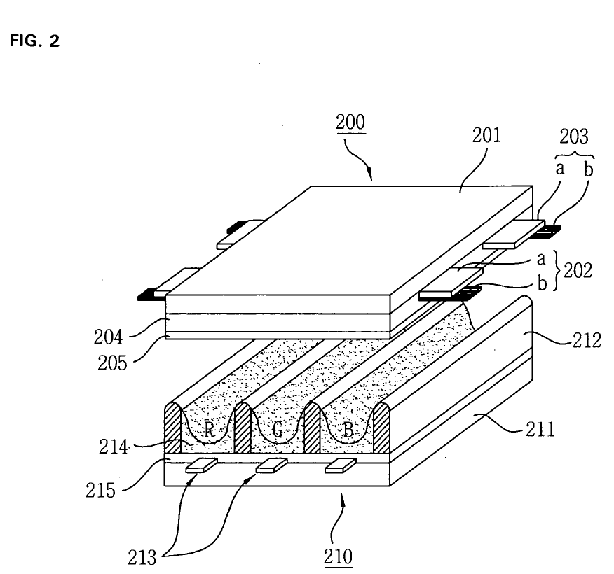

The following is a detailed description of the structure of the plasma display panel 100, with reference to FIG. 2.

FIG. 2 illustrates an example of the structure of a plasma display panel of the plasma display apparatus.

As illustrated in FIG. 2, the plasma display panel 100 of the plasma display apparatus according to the embodiment comprises a front panel 200 and a rear panel 210 which are coupled in parallel to oppose to each other at a given distance therebetween. The front panel 200 comprises a front substrate 201 which is a display surface. The rear panel 210 comprises a rear substrate 211 constituting a rear surface. A plurality of scan electrodes 202 and a plurality of sustain electrodes 203 are formed in pairs on the front substrate 201, on which an image is displayed. A plurality of address electrodes 213 are arranged on the rear substrate 111 to intersect the scan electrodes 202 and the sustain electrodes 203.

The scan electrode 202 and the sustain electrode 203 each comprise transparent electrodes 202a and 203a made of transparent indium-tin-oxide (ITO) material and bus electrodes 202b and 203b made of a metal material. The scan electrode 202 and the sustain electrode 203 generate a mutual discharge therebetween in one discharge cell and maintain light-emissions of the discharge cells.

The scan electrode 202 and the sustain electrode 203 are covered with one or more upper dielectric layers 204 to limit a discharge current and to provide insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) banier ribs 212 are formed in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear pane 210 is coated with Red (R), green (G) and blue (B) phosphors 214 for emitting visible light for an image display when an address discharge is performed. A lower dielectric layer 215 is formed between the address electrodes 213 and the phosphors 214 to protect the address electrodes 213.

Only an example of the plasma display panel applicable to the embodiment of the present invention was illustrated in FIG. 2. Accordingly, the plasma display panel is not limited to the structure of the plasma display panel illustrated in FIG. 2.

For example, in FIG. 2, the scan electrode 202 and the sustain electrode 203 each comprise the transparent electrode and the bus electrode. However, at least one of the scan electrode 202 and the sustain electrode 203 may comprise either the bus electrode or the transparent electrode.

Further, the structure of the plasma display panel, in which the front panel 200 comprises the scan electrode 202 and the sustain electrode 203 and the rear panel 210 comprises the address electrode 213, is illustrated in FIG. 2. However, the front panel 200 may comprise all the scan electrode 202, the sustain electrode 203 and the address electrode 213. At least one of the scan electrode 202, the sustain electrode 203 and the address electrode 213 may be formed on the barrier rib 212.

Considering the structure of the plasma display panel 100 of FIG. 2, the plasma display panel 100 applicable to the embodiment has only to comprise the scan electrode 202, the sustain electrode 203 and the address electrode 210. The plasma display panel 100 may have various structures except the above-described structural characteristic.

The description of FIG. 2 is completed, and the description of FIG. 1 continues again.

The scan driver 102 supplies a setup pulse and a set-down pulse to the scan electrode Y of the plasma display panel 100 during a reset period. Further, the scan driver 102 supplies a scan pulse to the scan electrode Y during an address period, and supplies a sustain pulse to the scan electrode Y during a sustain period.

The setup pulse is supplied to the scan electrode Y during the reset period through resonance between the plasma display panel 100 and an inductor. This will be described later.

The sustain driver 103 supplies a sustain pulse to the sustain electrode Z during the sustain period when an image is displayed. The scan driver 102 and the sustain driver 103 alternately operate.

The data driver 101 supplies a data pulse Vd to the address electrode X during the address period.

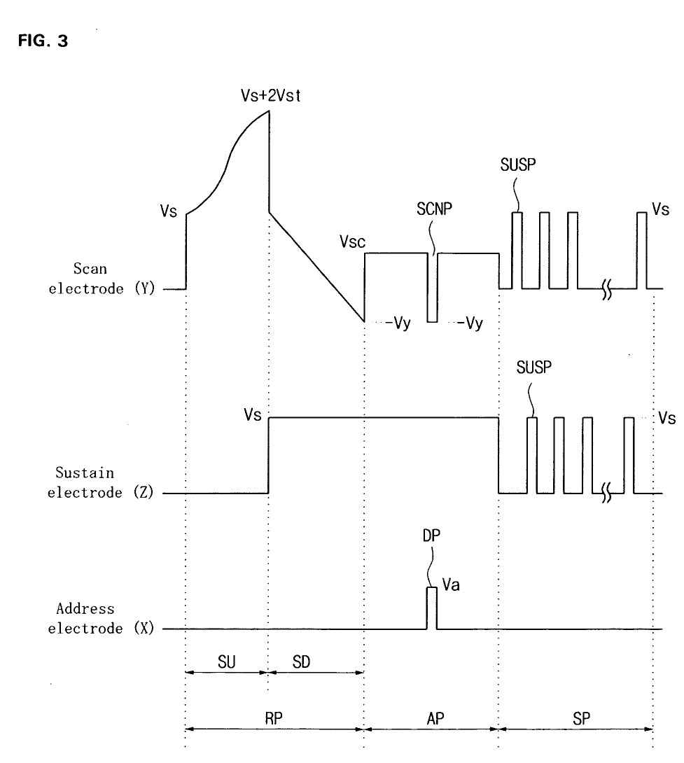

FIG. 3 illustrates a driving waveform produced by the plasma display apparatus according to the embodiment.

As illustrated in FIG. 3, each subfield comprises a reset period RP for initializing discharge cells of the whole screen, an address period AP for selecting cells to be discharged, and a sustain period SP for maintaining a discharge of the selected discharge cells.

The reset period RP is further divided into a setup period SU and a set-down period SD. During the setup period SU, a setup pulse gradually rising from a first voltage Vs to a second voltage (Vs+2Vst) is simultaneously supplied to all the scan electrodes Y, thereby generating a weak discharge (i.e., a setup discharge) within the discharge cells of the whole screen. This results in the forming of wall charges within the discharge cells.

The setup pulse of the driving waveform produced by the plasma display apparatus according to the embodiment illustrated in FIG. 3 is formed through resonance unlike the related art. The forming of the setup pulse will be described later.

During the set-down period SD, a set-down pulse, which falls from a positive sustain voltage Vs lower than the highest voltage of the setup pulse to a scan voltage −Vy of a negative polarity with a predetermined slope, is simultaneously supplied to the scan electrodes Y, thereby generating a weak erase discharge within the discharge cells. Accordingly, unnecessary charges of wall charges and space charges produced by the setup discharge are erased such that the remaining wall charges are uniform inside the discharge cells to the extent that the address discharge can be stably performed.

During the address period AP, a scan pulse SCNP of a negative polarity is sequentially supplied to the scan electrodes Y and, at the same time, a data pulse DP of a positive polarity is supplied to the address electrodes X. As the voltage difference between the scan pulse SCNP and the data pulse DP is added to the wall voltage generated during the reset period RP, the address discharge occurs within the discharge cells to which the data pulse DP is supplied. Wall charges are formed inside the discharge cells selected by performing the address discharge. The positive sustain voltage Vs is supplied to the sustain electrodes Z during the set-down period SD and the address period AP.

During the sustain period SP, a sustain pulse SUSP is alternately supplied to the scan electrodes Y and the sustain electrodes Z. As the wall voltage within the discharge cells selected by performing the address discharge is added to the sustain pulse SUSP, every time the sustain pulse SUSP is supplied, a sustain discharge of a surface discharge type occurs between the scan electrodes Y and the sustain electrodes Z.

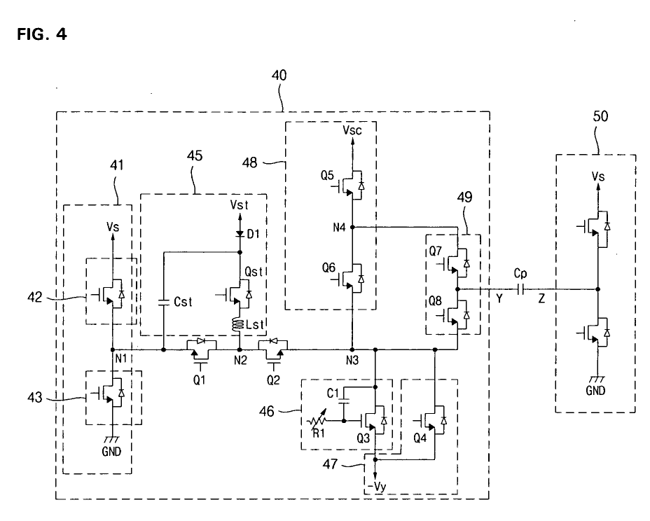

The following is a detailed description of the scan driver of the plasma display apparatus for supplying the above driving waveform of FIG. 3, with reference to FIG. 4.

FIG. 4 illustrates a scan driver of the plasma display apparatus according to the embodiment.

As illustrated in FIG. 4, the plasma display apparatus according to the embodiment comprises a scan driver 40 for driving the scan electrode Y of a panel capacitor Cp and a sustain driver 50 for driving the sustain electrode Z of the panel capacitor Cp.

The panel capacitor Cp equivalently indicates capacitance formed between the scan electrode Y and the sustain electrode Z of the plasma display panel.

The scan driver 40 comprises a sustain pulse supply unit 41, a first switch Q1, a setup pulse supply unit 45, a second switch Q2, a set-down pulse supply unit 46, a scan pulse supply unit 47, a scan reference voltage supply unit 48 and a scan integrated circuit 49.

The sustain pulse supply unit 41 supplies a sustain pulse having the first voltage (i.e., the sustain voltage Vs) and a ground level voltage GND to the scan electrode Y of the panel capacitor Cp during the sustain period.

The sustain pulse supply unit 41 comprises a sustain voltage supply controller 42 and a ground level voltage supply controller 43. The sustain voltage supply controller 42 is connected between a sustain voltage source (not illustrated) and the scan electrode Y to control the supplying of the sustain voltage Vs to the scan electrode Y. The ground level voltage supply controller 43 is connected between a ground level voltage source (not illustrated) and the scan electrode Y to control the supplying of the ground level voltage GND to the scan electrode Y.

The sustain voltage supply controller 42 is connected between the sustain voltage source and a first node N1 to supply the sustain voltage Vs to the scan electrode Y of the panel capacitor Cp during the setup period and the sustain period.

The sustain voltage supply controller 42 electrically connects the sustain voltage source to the first node N1 in response to a switching control signal supplied by a timing controller (not illustrated). As a result, the sustain voltage Vs is supplied to the first node N1 during the setup period and the sustain period.

The ground level voltage supply controller 43 is connected between the ground level voltage source and the first node N1 to supply the ground level voltage GND to the scan electrode Y of the panel capacitor Cp during the sustain period. The sustain voltage supply controller 42 and the ground level voltage supply controller 43 alternately operate during the sustain period.

The ground level voltage supply controller 43 electrically connects the ground level voltage source to the first node N1 in response to a switching control signal supplied by the timing controller.

The sustain voltage supply controller 42 and the ground level voltage supply controller 43 alternately operate during the sustain period such that the sustain voltage Vs and the ground level voltage GND are alternately supplied to the first node N1 during the sustain period.

The sustain voltage supply controller 42 and the ground level voltage supply controller 43 may comprise a field effect transistor. A drain terminal of the sustain voltage supply controller 42 is connected to the sustain voltage source, and a source terminal of the sustain voltage supply controller 42 is connected to a drain terminal of the ground level voltage supply controller 43. A source terminal of the ground level voltage supply controller 43 is connected to the ground level voltage source.

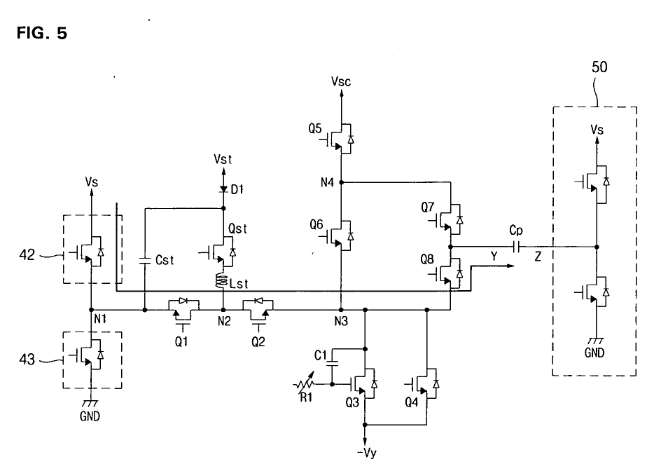

With the above configuration of the sustain pulse supply unit 41, as illustrated in FIG. 5, a current path passing through the sustain voltage source, the sustain voltage supply controller 42, the first switch Q1, the second switch Q2, an eighth switch Q8 and the panel capacitor Cp is formed during the setup period such that the sustain voltage Vs is supplied to the scan electrode Y of the panel capacitor Cp.

The setup pulse supply unit 45 is connected between the sustain pulse supply unit 41 and the scan electrode Y of the panel capacitor Cp to supply a setup pulse to the scan electrode Y during the setup period. The setup pulse supply unit 45 comprises a setup voltage source (not illustrated), a setup capacitor Cst, a setup switch Qst and a setup inductor Lst.

The setup voltage source supplies a setup voltage Vst to the scan electrode Y during the setup period.

The setup capacitor Cst is connected between the setup voltage source and the sustain pulse supply unit 41 such that the setup capacitor Cst is charged to the setup voltage Vst supplied from the setup voltage source.

The setup switch Qst is connected between the setup voltage source and the scan electrode Y to control the supplying of the setup voltage Vst to the scan electrode Y in response to a switching control signal supplied by the timing controller. The setup switch Qst may comprise a field effect transistor.

The setup inductor Lst is connected between the setup switch Qst and the scan electrode Y such that a charge voltage to the setup capacitor Cst is supplied to the scan electrode Y using series resonance between the setup inductor Lst and the panel capacitor Cp.

One terminal of the setup capacitor Cst is connected to the setup voltage source, and the other terminal of the setup capacitor Cst is connected to the drain terminal of the ground level voltage supply controller 43. A drain terminal of the setup switch Qst is commonly connected to one terminal of the setup capacitor Cst and the setup voltage source, and a source terminal of the setup switch Qst is connected to one terminal of the setup inductor Lst. The other terminal of the setup inductor Lst is connected to the scan electrode Y.

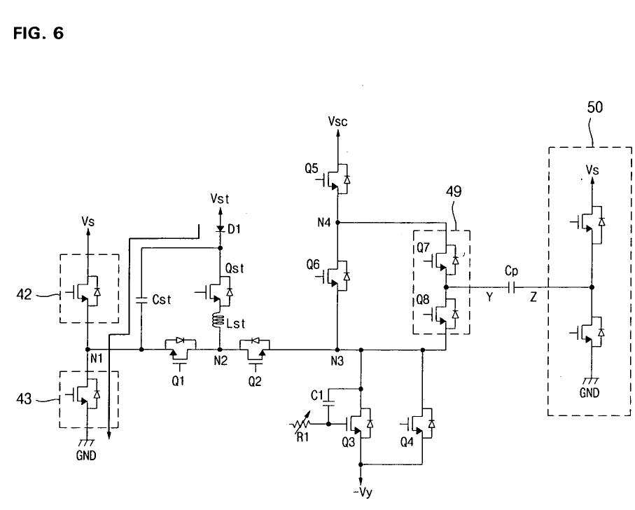

Since one terminal of the setup capacitor Cst is connected to the setup voltage source and the other terminal of the setup capacitor Cst is connected to the first node N1 being a common node of the source terminal of the sustain voltage supply controller 42 and the drain terminal of the ground level voltage supply controller 43, as illustrated in FIG. 6, a current path passing through the setup voltage source, the setup capacitor Cst, the ground level voltage supply controller 43 and the ground level voltage is formed such that the setup capacitor Cst is charged to the setup voltage level Vst.

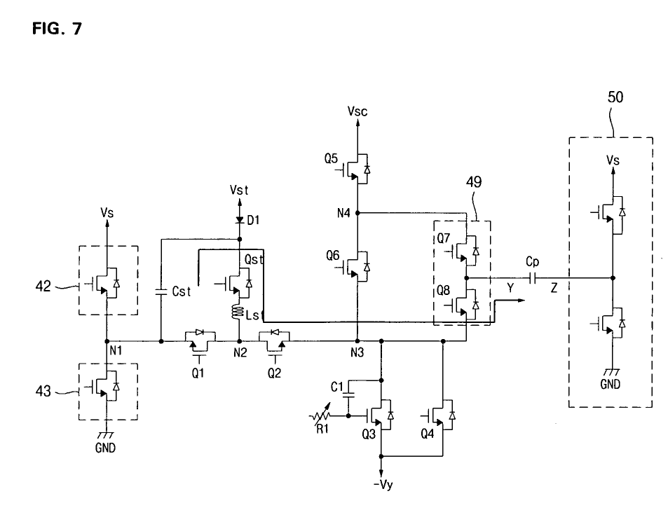

Since the drain terminal of the setup switch Qst is commonly connected to one terminal of the setup capacitor Cst and the setup voltage source, the source terminal of the setup switch Qst is connected to one terminal of the setup inductor Lst, and the other terminal of the setup inductor Lst is connected to the scan electrode Y, as illustrated in FIG. 7, a current path passing through the setup capacitor Cst, the setup switch Qst, the setup inductor Lst, the second switch Q2 and the panel capacitor Cp is formed such that the setup pulse gradually rising from the first voltage Vs to the second voltage (Vs+2Vst) is supplied to the scan electrode Y of the panel capacitor Cp using the charge voltage to the setup capacitor Cst through LC resonance between the setup inductor Lst and the panel capacitor Cp.

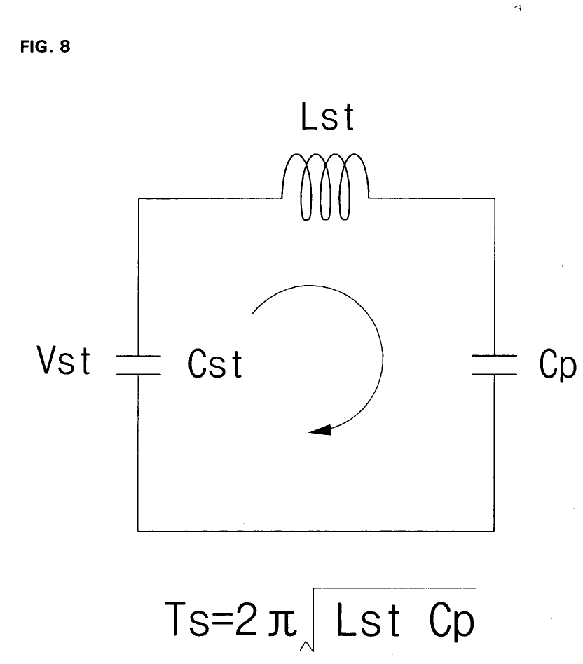

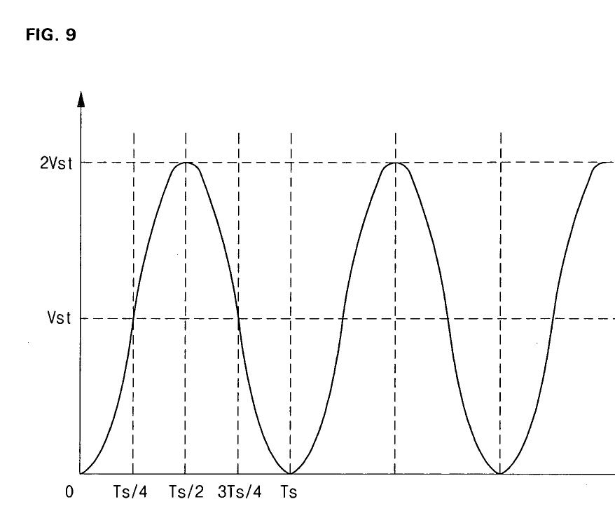

The following is a detailed description of the current path, with reference to FIGS. 8 and 9.

FIG. 8 illustrates an equivalent circuit of a closed loop formed by the current path illustrated in FIG. 7, and FIG. 9 illustrates a voltage supplied to a panel capacitor of FIG. 8.

As illustrated in FIG. 8, a closed loop formed by the current path illustrated in FIG. 7 is an equivalent series circuit being the connection of the setup capacitor Cst, the setup inductor Lst, the panel capacitor Cp and the setup capacitor Cst.

The setup capacitor Cst, as described above, remains in a charge state to the setup voltage Vst.

The equivalent circuit generates Lst-Cp series resonance between the setup inductor Lst and the panel capacitor Cp. A voltage illustrated in FIG. 9 is supplied to both terminals of the panel capacitor Cp.

A resonance period of a waveform of the voltage supplied to both terminals of the panel capacitor Cp is represented by the following Equation 1.
Ts=2π\sqrt{LstCp} [Equation 1]

In the above Equation 1, Ts indicates a resonance period of the closed loop illustrated in FIG. 8, Lst indicates inductance of the setup inductor, and Cp indicates capacitance of the panel capacitor.

It is preferable that the setup switch Qst operates in a saturation region. Since the setup switch Qst operates in a saturation region, power consumption in a driving operation of the plasma display panel is minimized and the stable driving of the plasma display panel is secured.

It is preferable to control the highest voltage of the setup pulse by controlling turn-on time of the setup switch Qst. It is preferable to control the turn-on time of the setup switch Qst in the range of one quarter to one half of the resonance period Ts.

As illustrated in FIGS. 8 and 9, by controlling the turn-on time of the setup switch Qst in consideration of the resonance period Ts of the Lst-Cp series resonance, the highest voltage (i.e., the second voltage) of the setup pulse may selected in the range of a voltage of Vs+Vst to a voltage of Vs+2Vst in accordance with a driving environment.

The setup pulse supply unit 45 may further comprise a reverse blocking diode D1, whose an anode terminal is connected to the setup voltage source and a cathode terminal is commonly connected to one terminal of the setup capacitor Cst and the drain terminal of the setup switch Qst. The reverse blocking diode D1 prevents the flowing of an inverse current from the setup capacitor Cst to the setup voltage source.

The set-down pulse supply unit 46 is connected between a third node N3 and the scan pulse supply unit 47. The set-down pulse supply unit 46 supplies a falling pulse falling from the ground level voltage GND to a scan voltage −Vy of a negative polarity with a predetermined slope to the scan electrode Y of the panel capacitor Cp during the reset period.

The set-down pulse supply unit 46 comprises a third switch Q3, a first variable resistance R1 and a first capacitor C1. The third switch Q3 is connected between the third node N3 and a scan voltage source. The first variable resistance R1 is connected to a gate terminal of the third switch Q3. The first capacitor C1 is connected between a common terminal of the gate terminal of the third switch Q3 and the first variable resistance R1 and the third node N3.

The third switch Q3 electrically connects the scan voltage source to the third node N3 in response to a switching control signal supplied by the timing controller.

Accordingly, the set-down pulse having the scan voltage level −Vy of the negative polarity is supplied to the third node N3 during the reset period. The set-down pulse supplied to the third node N3 has a predetermined slope.

The first variable resistance R1 and the first capacitor C1 are connected to the gate terminal of the third switch Q3 to control the predetermined slope of the set-down pulse. Accordingly, the set-down pulse with a negative slope is supplied to the third node N3 during the reset period.

The scan pulse supply unit 47 is connected to the third node N3 to supply a scan pulse SCNP having the scan voltage level −Vy of the negative polarity to the scan electrode Y of the panel capacitor Cp during the address period. The scan pulse supply unit 47 comprises the scan voltage source and a fourth switch Q4 connected between the scan voltage source and the third node N3.

The fourth switch Q4 transits the scan voltage level −Vy of the negative polarity supplied from the scan voltage source to the third node N3 in response to a switching control signal supplied by the timing controller. Accordingly, the scan voltage level −Vy of the negative polarity is transmitted to the third node N3 during the address period.

The scan reference voltage supply unit 48 is connected between the third node N3 and the scan integrated circuit 49 to supply the scan reference voltage Vsc to the scan electrode Y of the panel capacitor Cp during the address period.

The scan reference voltage supply unit 48 comprises a scan reference voltage source, a fifth switch Q5 and a sixth switch Q6 which are connected in series between the scan reference voltage source and the third node N3.

The fifth switch Q5 is connected between the scan reference voltage source and the scan integrated circuit 49. The fifth switch Q5 electrically connects the scan reference voltage source to a fourth node N4 in response to a switching control signal supplied by the timing controller.

Accordingly, the scan reference voltage Vsc is transmitted to the fourth node N4 during the address period. The fourth node N4 is a common node of the fifth switch Q5, the sixth switch Q6 and the scan integrated circuit 49.

The sixth switch Q6 is connected between the third node N3 and the fourth node N4. The sixth switch Q6 electrically connects the third node N3 to the fourth node N4 in response to a switching control signal supplied by the timing controller.

Accordingly, the voltage supplied to the third node N3 is transmitted to the fourth node N4, and the voltage supplied to the fourth node N4 is transmitted to the third node N3.

The scan integrated circuit 49 comprises a seventh switch Q7 and an eighth switch Q8 which are connected between the third node N3 and the fourth node N4 in a push-pull form. A common node of the seventh switch Q7 and the eighth switch Q8 is connected to the scan electrode Y of the panel capacitor Cp.

The seventh switch Q7 supplies the voltage supplied to the fourth node N4 to the scan electrode Y of the panel capacitor Cp through a body diode of the seventh switch Q7.

In other words, the seventh switch Q7 electrically connects to the scan electrode Y of the panel capacitor Cp to the fourth node N4 through the body diode of the seventh switch Q7 such that when a voltage of a negative polarity is supplied to the fourth node N4, the voltage supplied to the fourth node N4 is supplied to the scan electrode Y of the panel capacitor Cp.

Accordingly, the voltage of the negative polarity supplied to the fourth node N4 is supplied to the scan electrode Y of the panel capacitor Cp.

The eighth switch Q8 supplies the voltage supplied to the third node N3 to the scan electrode Y of the panel capacitor Cp through a body diode of the eighth switch Q8.

In other words, the eighth switch Q8 electrically connects to the scan electrode Y of the panel capacitor Cp to the third node N3 through the body diode of the eighth switch Q8 such that when a voltage of a positive polarity is supplied to the third node N3, the voltage supplied to the third node N3 is supplied to the scan electrode Y of the panel capacitor Cp.

Accordingly, the voltage of the positive polarity supplied to the third node N3 is supplied to the scan electrode Y of the panel capacitor Cp.

The sustain driver 50 supplies a bias voltage of a positive polarity having the sustain voltage level Vs to the sustain electrode Z of the panel capacitor Cp during the set-down period and the address period. Further, the sustain driver 50 supplies the sustain pulse having the ground level voltage GND and the sustain voltage level Vs to the sustain electrode Z of the panel capacitor Cp during the sustain period.

As described above, since the plasma display apparatus according to the embodiment generates the setup pulse using the saturation region of the setup switch Qst during the setup period, a problem of the generation of heat is solved in the driving process of the plasma display panel, thereby securing the stable driving of the plasma display panel. Further, the configuration of the circuit components is simple, thereby reducing the manufacturing cost of the plasma display panel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a scan electrode; and
a scan driver for supplying a setup pulse to the scan electrode through resonance between the plasma display panel and a setup inductor.

2. The plasma display apparatus of claim 1, wherein the scan driver comprises
a setup capacitor charged to a setup voltage supplied from a setup voltage source,
a setup switch, connected between the setup voltage source and the scan electrode, for controlling the supplying of the setup voltage to the scan electrode, and
the setup inductor connected between the setup switch and the scan electrode.

3. The plasma display apparatus of claim 1, wherein a magnitude of the highest voltage of the setup pulse ranges from a sum of a magnitude of a sustain voltage and a magnitude of a setup voltage to a sum of the magnitude of the sustain voltage and two times the magnitude of the setup voltage.

4. A plasma display apparatus comprising:
a plasma display panel comprising a scan electrode;
a sustain pulse supply unit for supplying a first voltage to the scan electrode; and
a setup pulse supply unit for supplying a setup pulse gradually rising from the first voltage to a second voltage to the scan electrode through resonance between the plasma display panel and an inductor.

5. The plasma display apparatus of claim 4, wherein the first voltage is equal to a sustain voltage level.

6. The plasma display apparatus of claim 5, wherein the setup pulse supply unit comprises
a setup capacitor charged to a setup voltage supplied from a setup voltage source,
a setup switch, connected between the setup voltage source and the scan electrode, for controlling the supplying of the setup voltage to the scan electrode, and
a setup inductor, connected between the setup switch and the scan electrode, for supplying a charge voltage to the setup capacitor to the scan electrode through resonance between the plasma display panel and the setup inductor.

7. The plasma display apparatus of claim 6, wherein a magnitude of a difference between the second voltage and the first voltage ranges from a magnitude of the setup voltage to two times the magnitude of the setup voltage.

8. The plasma display apparatus of claim 6, wherein the sustain pulse supply unit comprises
a sustain voltage supply controller, connected between the scan electrode and a sustain voltage source, for controlling the supplying of the sustain voltage to the scan electrode, and
a ground level voltage supply controller, connected between the scan electrode and a ground level voltage source, for controlling the supplying of a ground level voltage to the scan electrode.

9. The plasma display apparatus of claim 8, wherein a current path for charging the setup capacitor to the setup voltage passes through the setup voltage source, the setup capacitor, the ground level voltage supply controller and the ground level voltage source.

10. The plasma display apparatus of claim 8, wherein a current path for supplying a charge voltage to the setup capacitor to the scan electrode through the resonance between the plasma display panel and the setup inductor passes through the setup capacitor, the setup switch, the setup inductor and the plasma display panel.

11. The plasma display apparatus of claim 8, wherein one terminal of the setup capacitor is connected to the setup voltage source, and the other terminal of the setup capacitor is connected to a drain terminal of the ground level voltage supply controller,
a drain terminal of the setup switch is commonly connected to one terminal of the setup capacitor and the setup voltage source, and a source terminal of the setup switch is connected to one terminal of the setup inductor, and
the other terminal of the setup inductor is connected to the scan electrode.

12. The plasma display apparatus of claim 4, wherein the setup pulse supply unit comprises an inductor.

13. A method of driving the plasma display apparatus comprising:
supplying a first voltage to a scan electrode during a reset period; and
supplying a pulse gradually rising from the first voltage to a second voltage to the scan electrode during the reset period through resonance between a plasma display panel and an inductor.

14. The method of claim 13, wherein the first voltage is equal to a sustain voltage level.

15. The method of claim 13, wherein the supplying of the pulse gradually rising from the first voltage to the second voltage comprises charging a setup capacitor to a setup voltage, and supplying a charge voltage to a setup capacitor to the scan electrode through the resonance between the plasma display panel and the inductor.

16. The method of claim 15, wherein a magnitude of a difference between the second voltage and the first voltage ranges from a magnitude of the setup voltage to two times the magnitude of the setup voltage.
